(19) United States
(12) Patent Application Publication
(10) Pub. No.: US 2009/0185071 A1
(43) Pub. Date: Jul. 23, 2009

(54) Portable Electronic Apparatus

(75) Inventors: Tatsuya SUZUKI, Tokyo (JP); Tsuyoshi FUKUTA, Tokyo (JP)

Correspondence Address: HOGAN & HARTSON L.L.P., 1999 AVENUE OF THE STARS, SUITE 1400, LOS ANGELES, CA, 90067, US

(73) Assignees: Olympus Corporation, Tokyo (JP); Olympus Imaging Corp., Tokyo (JP)

(21) Appl. No.: 12/398,037

(22) Filed: Mar. 4, 2009

Related U.S. Application Data
(63) Continuation of application No. PCT/JP2008/052213, filed on Feb. 5, 2008.

(30) Foreign Application Priority Data
Feb. 5, 2007 (JP) 2007-025419

(51) Int. Cl. H04N 5/225

(52) U.S. Cl. 348/375; 348/376; 348/E05.024

(57) ABSTRACT

A portable electronic apparatus includes an exterior member which houses a main body of the apparatus and has an opening, a part of the main body being exposed through the opening; a lid which is attached to the exterior member so as to cover or uncover the opening; a hook which is provided in an area of the main body to be covered with the lid and on which a small loop for attachment of a strap is hooked; and a projection which projects from the lid and which comes in contact with a head part of the hook with the lid closed. A boundary surface of the covered area, the hook, and the projection forms a closed planar area with the lid closed.

### CROSS-REFERENCE TO RELATED APPLICATIONS

This application is a continuation of PCT international application Ser. No. PCT/JP2008/052213 filed Feb. 5, 2008 which designates the United States, incorporated herein by reference, and which claims the benefit of priority from Japanese Patent Application No. 2007-025419, filed Feb. 5, 2007, incorporated herein by reference.

### BACKGROUND OF THE INVENTION

1. Field of the Invention

The present invention relates to a small portable electronic apparatus.

2. Description of the Related Art

Small portable electronic devices, such as digital cameras, mobile phones, and digital voice recorders, have strap attaching parts to which straps are attached. Such a device is hung from a user's hand, neck, or shoulder through a strap to prevent the device from falling. The strap attaching part is typically provided on the surface of the small portable electronic device. For example, refer to Japanese Patent Application Laid-open Nos. 2003-84358, 2003-273529, 2003-295279, 2004-258220, and 2006-39332.

### SUMMARY OF THE INVENTION

A portable electronic apparatus according to an aspect of the present invention includes an exterior member which houses a main body of the apparatus and has an opening, a part of the main body being exposed through the opening; a lid which is attached to the exterior member so as to cover or uncover the opening; a hook which is provided in an area of the main body to be covered with the lid and on which a small loop for attachment of a strap is hooked; and a projection which projects from the lid and which comes in contact with a head part of the hook with the lid closed. A boundary surface of the covered area, the hook, and the projection forms a closed planar area with the lid closed.

A portable electronic apparatus according to another aspect of the present invention includes an exterior member which houses a main body of the apparatus and has an opening, a part of the main body being exposed through the opening; a lid which is attached to the exterior member so as to cover or uncover the opening; and a hook which is provided in an area of the main body to be covered with the lid and on which a small loop for attachment of a strap is hooked, a head part of the hook being possible to be lifted from a boundary surface of the covered area. The boundary surface of the covered area and the hook forms a closed planar area at least with the lid closed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of the structure of a portable electronic apparatus, herein exemplified as a digital camera, according to a first embodiment of the present invention;

FIG. 2 is a relevant bottom perspective view of the structure of the portable electronic apparatus, herein exemplified as the digital camera, according to the first embodiment of the present invention;

FIG. 3 is a view of the structure shown in FIG. 2 with a lid opened;

FIG. 4 is a view of the structure of an area covered with the lid closed in the portable electronic apparatus (digital camera) according to the first embodiment of the present invention;

FIG. 5 is a view of main parts of a portable electronic apparatus (digital camera) according to a first modification of the first embodiment;

FIG. 6 is a view of the structure of an area covered with the lid closed in the portable electronic apparatus (digital camera) according to the first modification of the first embodiment;

FIG. 7 is a view of main parts of a portable electronic apparatus (digital camera) according to a second modification of the first embodiment;

FIG. 8 is a perspective view of the structure of a portable electronic apparatus (digital camera) according to a second embodiment of the present invention;

FIG. 9 is a view of the structure of the portable electronic apparatus (digital camera), with a lid opened, according to the second embodiment, the lid being provided on a lateral side of the portable electronic apparatus;

FIG. 10 is a view of main parts of a portable electronic apparatus (digital camera) according to a third embodiment of the present invention;

FIG. 11 is a view of the structure of an area covered with the lid closed in the portable electronic apparatus (digital camera) according to the third embodiment;

FIG. 12 schematically illustrates a process of attaching a strap to the portable electronic apparatus (digital camera) according to the third embodiment;

FIG. 13 is a view of main parts of a portable electronic apparatus (digital camera) according to a fourth embodiment of the present invention; and

FIG. 14 is a view of main parts of the portable electronic apparatus, with a lid opened, according to the fourth embodiment.

### DETAILED DESCRIPTION OF THE PREFERRED EMBODIMENTS

The best modes for carrying out the present invention, hereinafter referred to as embodiments, are described below with reference to the attached drawings. The figures are merely schematic diagrams, and thus, when the same components are shown in different figures, their dimensions and scales may differ.

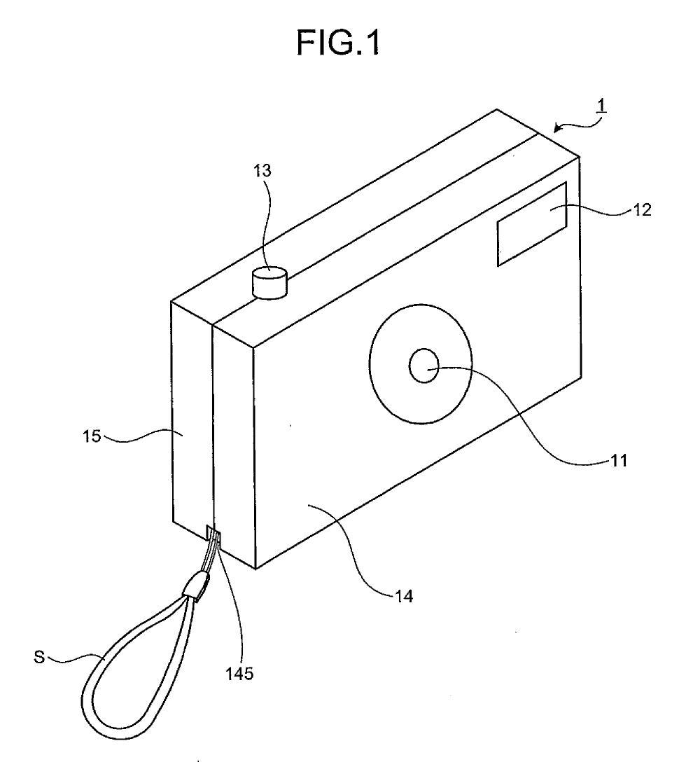

FIG. 1 is a perspective view of an exterior structure of a digital camera, which is a portable electronic apparatus according to a first embodiment. A digital camera 1 shown in FIG. 1 generates image data in such a way that light collected and focused through a taking lens is subjected to photoelectrical conversion to be an electric signal, and the electric signal is subjected to a prescribed image processing. The digital camera 1 includes an image pickup unit 11 having the taking lens; a flashbulb 12 for strobe lighting; a shutter release button 13 which may be pressed while taking a picture; and two covering members 14 and 15 constituting the exterior member which houses the main body of the digital camera 1. A strap S is attached to a prescribed portion of the digital camera 1 shown in FIG. 1.

The main body of the digital camera 1 includes electronic components (not shown), which achieve various functions such as image pickup process, and the electronic components include a control circuit comprising a CPU (Central Processing Unit) and the like to control the drive of the digital camera 1; a solid-state image sensing device such as CCD (Charge Coupled Device) or CMOS (Complementary Metal Oxide Semiconductor); a microphone for audio input and a speaker for audio output; and a drive circuit which drives functional components under the control of the control circuit. A display unit, e.g., an LCD (Liquid Crystal Display) to display image and textual information, operation buttons used for inputting the necessary information for operation of the digital camera 1, and others (not shown) are exposed on the rear covering member 15. The structures not shown here may be the same as those of the conventional digital camera.

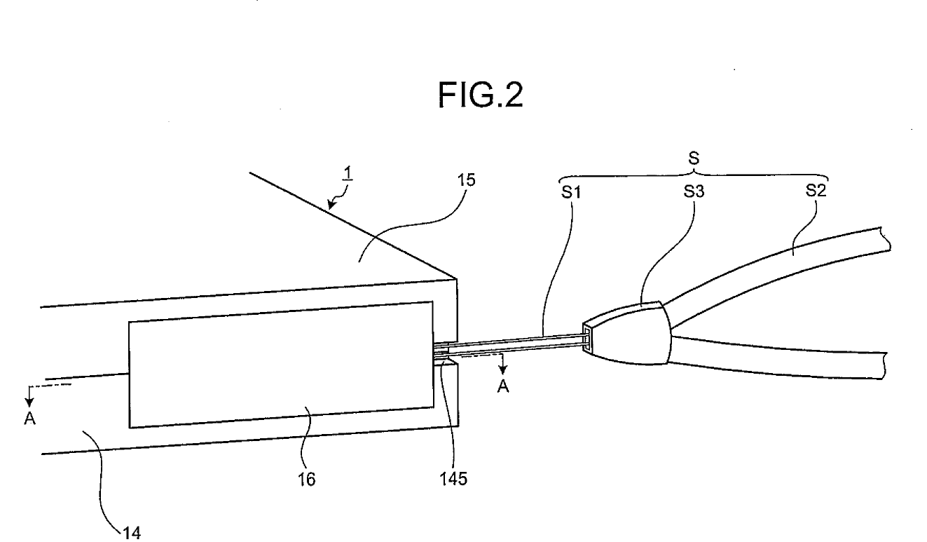

FIG. 2 is a relevant bottom respective view of the structure of the digital camera 1. The term “bottom” is used to mean a side opposite to the side on which the shutter release button 13 is exposed (referred to as the top side). A lid 16 is provided at the bottom of the digital camera 1, covering an opening of the exterior member, i.e., the covering members 14 and 15. The lid 16 has a rectangular shaped surface, and rotates around the rotational axis which is near the short side on the left in FIG. 1 to be opened and closed. This opening and closing mechanism can be achieved by, for example, providing a hinge on the short side of the lid. The lid 16 shown in FIG. 2 is locked with a prescribed locking mechanism (not shown).

A groove-like slot 145, which connects to the area covered with the lid 16, is formed around a ridge line bounding the bottom and a lateral side of the digital camera 1 on a border between the covering members 14 and 15. The strap S attached to the digital camera 1 in the covered area is led out through a groove-like slot 145. Since the slot 145 is formed around the ridge line bounding the bottom and the lateral side of the digital camera 1, the strap S will not come into contact with, for example, the user's palm while the user holds the digital camera 1. Therefore, the user can concentrate on taking pictures without discomfort caused by the contact with the strap S.

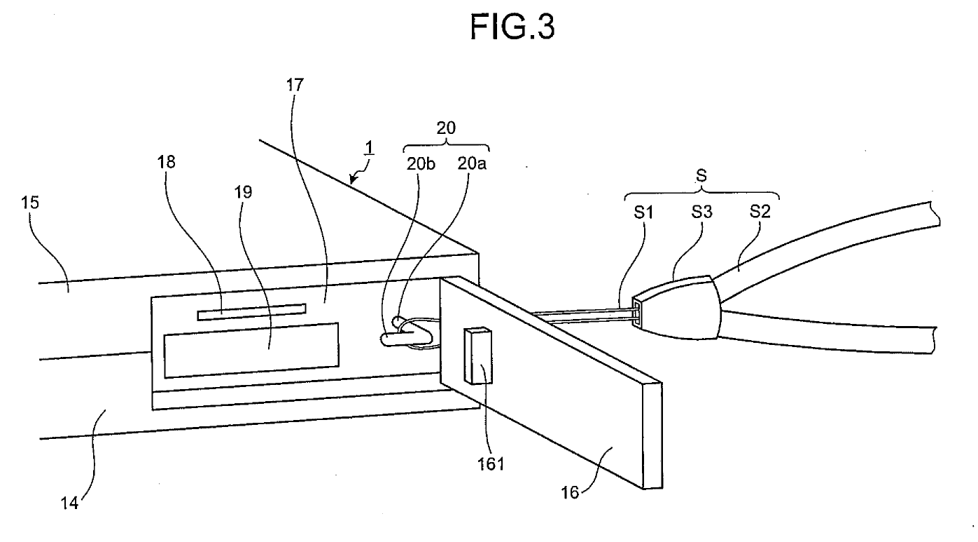

FIG. 3 shows a state with the lid 16 opened, showing the structure of a rear side of the lid 16, the structure of the area covered with the lid 16, and how the strap S is attached to the main body. As shown in FIG. 3, the rear side of the lid 16 is provided with a projection 161, which projects perpendicularly from the surface of the rear side. A recess 17, which is a portion of the main body of the digital camera 1, is formed in the covered area. Loading slots 18 and 19 for a portable storage medium such as a flash memory, and a battery such as a lithium ion battery, respectively, and a hook 20 on which the strap S is hooked, are provided on a bottom of the recess 17.

The hook 20 has an L-shape and specifically has a base part 20a projecting perpendicularly from the surface of the bottom of the recess 17, and a head part 20b projecting from a distal end of the base part 20a in the direction perpendicular to the base part 20a. The hook 20 is preferably made of highly rigid metal or resin and it may be integrally formed as with the recess 17, or it may be formed as a separate part. In the latter case, the separate part formed as the hook 20 may be provided on the bottom of the recess 17.

The structure of the strap S will be described. The strap S has a small loop Si which is to be attached to the digital camera 1, a large loop S2 through which a part of the user's body, e.g., a hand is put, and a connecting part S3 which connects the small loop S1 and the large loop S2. A hand strap, a neck strap, and a shoulder strap, the large loops S2 of which are put through a hand, a neck, and a shoulder, respectively, and the like, are examples of the strap S. The small loop S1, which is attached to the digital camera 1, is led out through the groove-like slot 145. Therefore, an end portion of the small loop S1 is covered by the lid 16 with the lid 16 closed, and thus is not seen from outside of the digital camera 1 (refer to FIG. 1 and FIG. 2).

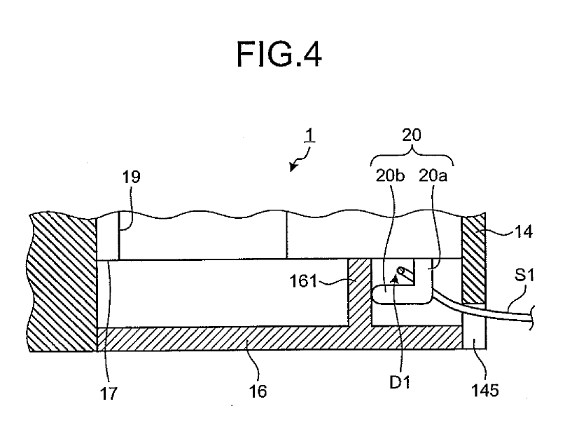

When the strap S is attached to the digital camera 1, firstly the end portion of the small loop S1 is put into the recess 17 through the slot 145 with the lid 16 opened, and then the small loop S1 is hooked on to the head part 20b of the hook 20. In this state shown in FIG. 3, although the small loop S1 is merely hooked on to the hook 20, the small loop S1 is securely attached to the digital camera 1 after the lid 16 is closed. This mechanism will be described below with reference to FIG. 4.

FIG. 4 is a partial perspective view taken along A-A line of FIG. 2, showing the internal structure of the covered area with the lid 16 closed. In FIG. 4, a distal end portion of the projection 161 comes into contact with the bottom of the recess 17. A lateral side of the projection 161 comes in contact with the head part 20b of the hook 20. In this state, the hook 20, the projection 161, and the bottom of the recess 17 form a closed planar area D1. The small loop S1 hooked on to the hook 20 crosses the planar area D1 only once, thereby prevented from being detached from the digital camera 1 with the lid 16 closed.

As described above, in the first embodiment, the hook 20 and the projection 161 are provided in the area covered with the lid 16, and form the closed planar area D1 together with the recess 17, which is a boundary surface of the covered area.

In the first embodiment, the strap S is attached to the digital camera 1 in a manner that the lid 16 is closed after the small loop S1 is hooked on to the head part 20b, unlike the conventional way that the large loop S2 is put through the small loop S1 to tie a knot. This makes it easy to attach the strap S. Moreover, the strap S is detached in a manner that the lid 16 is opened and then the small loop S1 is detached from the head part 20b. This procedure is easy.

In the first embodiment, the head part 20b of the hook 20 is not located at least on the same side as the slot 145 with respect to the base part 20a. Moreover, the rotational axis for the rotation of the lid 16 is located in between the hook 20 and the slot 145. Accordingly, even if the user pulls the strap S in any direction, the lid 16 will not be opened, and thus the strap S is not accidentally detached from the digital camera 1. This allows the digital camera 1 to be reliably hung.

The portable electronic apparatus according to the first embodiment of the present invention described above includes the lid which covers or uncovers the opening on the exterior member housing the main body; the hook which is provided in the area of the main body to be covered with the lid and on which the small loop for attachment of the strap is hooked; and the projection which projects from the lid and which comes in contact with the head part of the hook with the lid closed. The boundary surface of the covered area, the hook, and the projection form the closed planar area with the lid closed. The strap can be attached to the portable electronic apparatus in a manner that the small loop is hooked to the hook and then the lid is closed, so as to cross the closed planar area only once. Therefore, this allows easy attachment and detachment of the strap without tying the knot which is required in the conventional way that the main part of the strap is put through the small loop.

According to the first embodiment, the slot through which the small loop is led out is further provided, and the head part of the hook is not located at least on the same side as the slot with respect to the base part of the hook. This configuration prevents the attached strap from being detached from the main body of the portable electronic apparatus with the lid closed.

According to the first embodiment, the lid covers or uncovers the opening by rotation, and the rotational axis is located in between the hook and the slot. This configuration prevents the lid from accidentally opening due to a force caused by the strap. In other words, the strap can be prevented from being detached from the main body of the portable electronic apparatus.

According to the first embodiment, since the strap attaching part is covered with the lid, the strap attaching part is not seen from outside. Therefore, the overall beauty of the apparatus is not spoiled by the strap attaching part even if the strap is attached, and users who do not use straps can escape caring about the strap attaching part.

According to the first embodiment, the attached strap is led outside through the vicinity of the ridge line on the bottom of the substantially rectangular exterior member. Therefore, the user is not disturbed by the strap attaching part and the strap, for example, coming into contact with the user's palm, and can concentrate on taking a picture with good usability even with the strap.

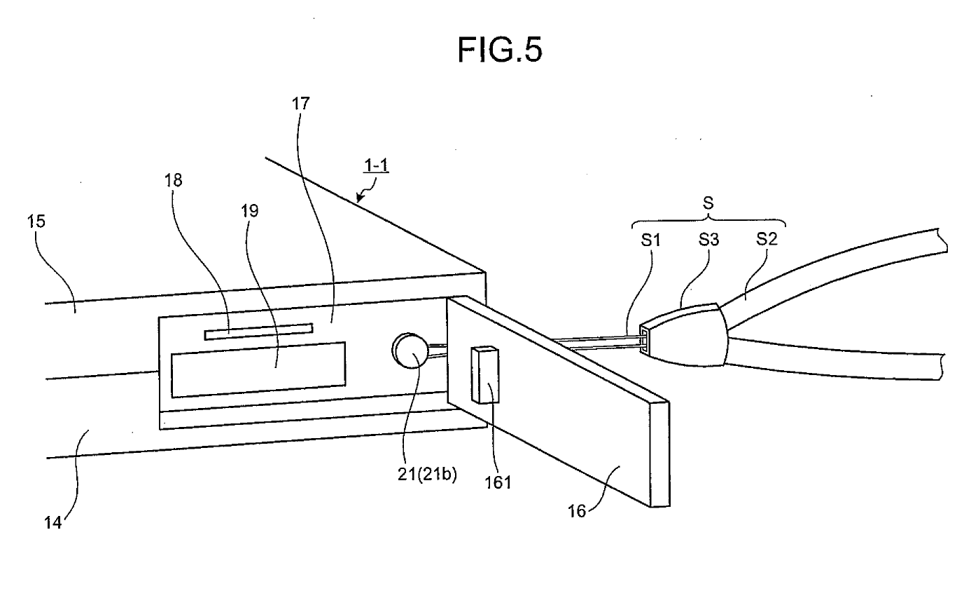

FIG. 5 is a view of main parts of a digital camera, which is a portable electronic apparatus according to a first modification of the first embodiment, with a lid on its bottom opened. A digital camera 1-1 shown in FIG. 5 has the same structure as that of the digital camera 1, except a hook on which a strap is hooked. The same parts as those of the digital camera 1 are denoted by the corresponding reference numerals in FIG. 3.

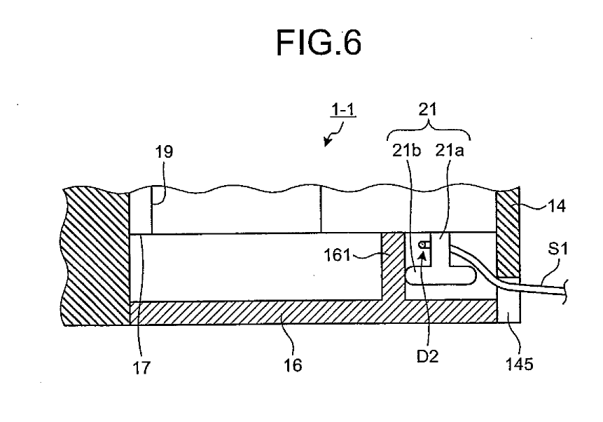

FIG. 6 is a partial cross-sectional view of the corresponding parts in FIG. 4 described in the first embodiment, showing the structure of an area covered with the lid 16 closed. As shown in FIGS. 5 and 6, a hook 21 is like a pin as a whole, and specifically has a base part 21a projecting perpendicularly from the surface of the bottom of the recess 17, and a disc-like head part 21b, which is on a distal end of the base part 21a, having a central axis substantially identical with the axis of the base part 21a. The hook 21 is preferably made of highly rigid metal or resin.

In FIG. 6, the end portion of a projection 161 comes in contact with the bottom of the recess 17, and the lateral side of the projection 161 comes in contact with the disc-like head part 21b. In this state, the hook 21, the projection 161, and the bottom of the recess 17 form a closed planar area D2. The small loop S1 hooked on to the hook 21 crosses the planar area D2 only once. Accordingly, the small loop S1 is prevented from being detached from the digital camera 1-1 with the lid 16 closed.

The first modification has, as the first embodiment described above, such a structure for which the lid will not open even when the strap is pulled in any direction, thereby preventing the strap S from being detached from the digital camera 1-1. This allows the digital camera 1-1 to be hung reliably.

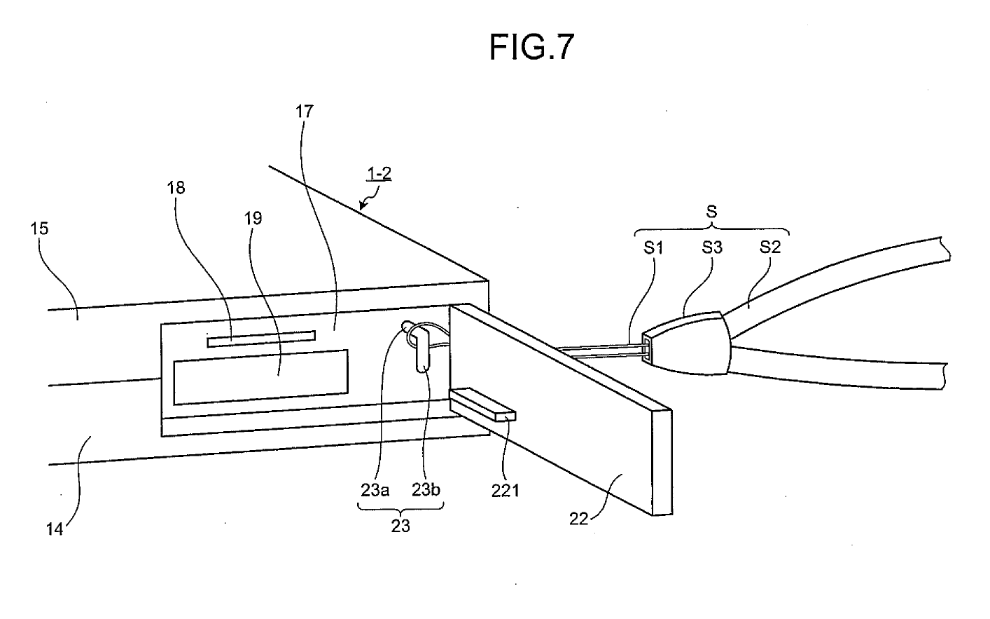

FIG. 7 is a view of main parts of a digital camera, which is a portable electronic apparatus according to a second modification of the first embodiment, with a lid on its bottom opened. A digital camera 1-2 shown in FIG. 7 has the same structure as that of the digital camera 1, except a lid 22 and a hook 23. The same parts as those of the digital camera 1 are denoted by the corresponding reference numerals in FIG. 3.

The hook 23 has an L-shape and specifically has a base part 23a projecting perpendicularly from the surface of the bottom of the recess 17, and a head part 23b projecting from a distal end of the base part 23a in the direction perpendicular to the base part 23a. The hook 23 is preferably made of highly rigid metal or resin.

The second modification is different from the first embodiment described above in that the head part 23b extends in the width direction of the bottom of the digital camera 1-2 (i.e., the vertical direction in FIG. 7). Accordingly, a projection 221 formed on the lid 22 projects so as to come in contact with the end of the head part 23b with the lid 22 closed.

When the lid 22 is closed in the state shown in FIG. 7, an end portion of the projection 221 comes in contact with the bottom of the recess 17, and a lateral side of the projection 221, which is a top side in FIG. 7, comes in contact with the end of the head part 23b of the hook 23. In this state, the hook 23, the projection 221, and the bottom of the recess 17 form a closed planar area, as the first embodiment described above. The small loop S1 hooked on to the hook 23 only once crosses the planar area formed by closing the lid 22, thereby is prevented from being detached from the digital camera 1-2.

The second modification has such a structure for which the lid will not open even when the strap S is pulled in any direction, as the first modification. Therefore, the strap S is not accidentally detached from the digital camera 1-2. This allows the digital camera 1-2 to be reliably hung.

According to the two modifications of the first embodiment described above, the portable electronic apparatus capable of easy attachment and detachment of the strap is provided, as the first embodiment.

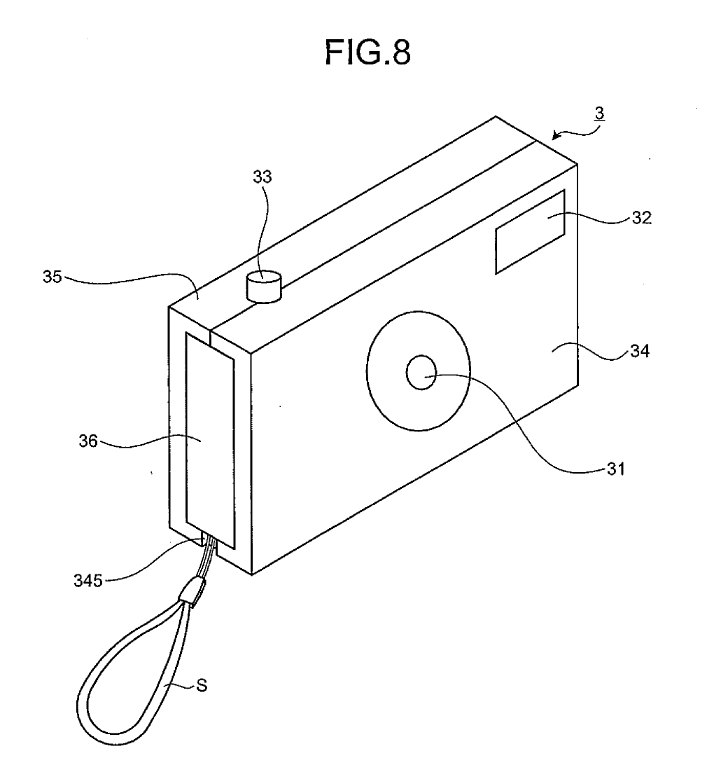

FIG. 8 is a perspective view of an exterior structure of a digital camera, which is a portable electronic apparatus according to a second embodiment of the present invention. A digital camera 3 shown in FIG. 8 includes an image pickup unit 31, a flashbulb 32, and a shutter release button 33. The digital camera 3 also includes two covering members 34 and 35 constituting an exterior member housing a main body of the digital camera 3. The structure of a rear side of the digital camera 3 in FIG. 8 and a functional structure of its main body are the same as those of the digital camera 1 according to the first embodiment.

The exterior member housing the main body of the digital camera 3 has an opening on its lateral side. The term “lateral side” is used to mean a side which intersects both with a front side on which the image pickup unit 31 is provided and with a top side on which the shutter release button 33 is provided. In the case of FIG. 8, the lateral side is orthogonal to both the front side and the top side. A lid 36, which cover or uncover the opening, is provided on the lateral side of the exterior member having the opening. The lid 36 has a rectangular surface, and rotates around the rotational axis which is near the long side on the left in FIG. 8 to be opened and closed. This opening and closing mechanism can be achieved by, for example, providing a hinge on the long side of the lid. The lid 36 shown in FIG. 8 is locked with a prescribed locking mechanism (not shown) to prevent the lid from opening accidentally.

The strap S, which is attached to the digital camera 3, is led out from the digital camera 3 through a slot 345, which is formed at an area including a border between the covering members 34 and 35. Therefore, an end portion of the small loop S1 is covered by the lid 36 with the lid 36 closed, and thus is not seen from outside of the digital camera 3.

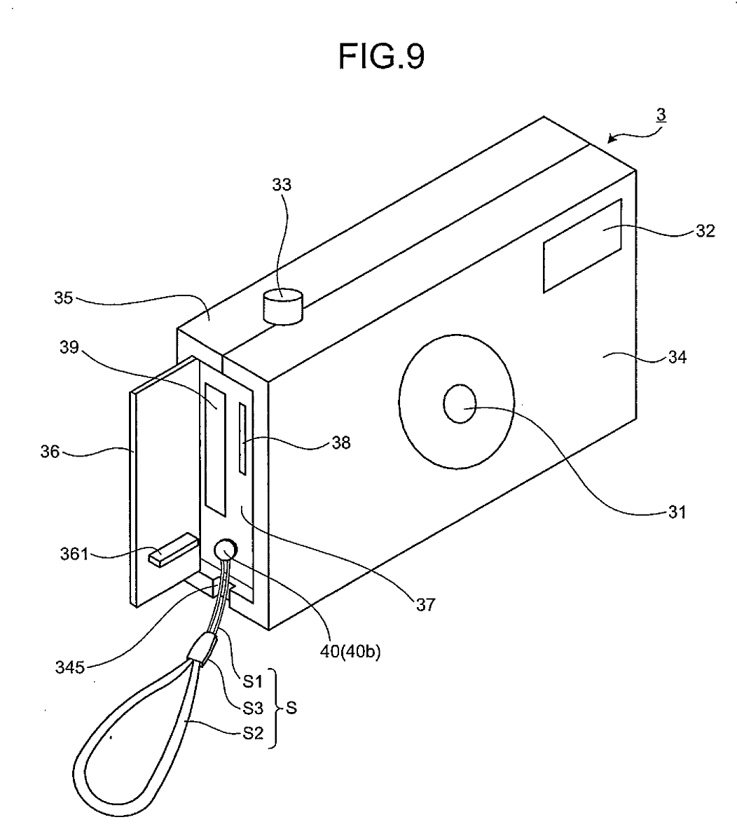

A structure of an area covered with the lid 36 is described below. FIG. 9 shows a state with the lid 36 opened, and how the strap S is attached to the main body. On a rear side of the lid 36, a projection 361 projecting perpendicularly from the surface of the rear side is provided. A recess 37, which is a portion of the main body of the digital camera 3, is formed in the covered area. Loading slots 38 and 39 for a portable storage medium and for a battery, respectively, and a hook 40 on which the strap S is hooked, are provided on a bottom of the recess 37. The hook 40 is preferably made of highly rigid metal or resin.

The hook 40 is like a pin as a whole, and specifically has a base part 40a (not shown) and a head part 40b, as the hook 21 shown in FIG. 5. An end portion of the projection 361 comes in contact with the bottom of the recess 37, and a lateral side of the projection 361, which is the lower side in FIG. 9, comes in contact with an end of the head part 40b of the hook 40, with the lid 36 closed. In this state, the hook 40, the projection 361, and the bottom of the recess 37 form a closed planar area. The internal structure of the covered area with the lid 36 closed is the same as in FIG. 6, and the planar area formed is the same as the planar area D2 in FIG. 6. The small loop S1 hooked on to the hook 40 crosses the planar area only once, thereby is prevented from being detached from the digital camera 3.

In the second embodiment, the strap S can be attached to the digital camera 3 in a manner that the lid 36 is closed after the small loop S1 of the strap S is hooked on to the disc-like head part 40b of the hook 40. This makes it easy to attach the strap S. Moreover, the strap S is detached in a manner that the lid 36 is opened and then the small loop S1 is detached from the head part 40b. This procedure is easy.

In the second embodiment, a place where the hook 40 and the projection 361 come in contact with each other with the lid 36 closed is not located at least on the same side as the slot 345 with respect to the base part 40a of the hook 40. Therefore, the strap S is not accidentally detached from the digital camera 3, thereby allowing the digital camera 3 to be reliably hung.

The portable electronic apparatus according to the second embodiment of the present invention described above includes the lid which covers or uncovers the opening on the exterior member housing the main body; the hook which is provided in the area of the main body to be covered with the lid and on which the small loop for attachment of the strap is hooked; and the projection which projects from the lid and which comes in contact with the head part of the hook with the lid closed. The boundary surface of the covered area, the hook, and the projection form the closed planar area with the lid closed. The strap can be attached to the portable electronic apparatus in a manner that the small loop is hooked on to the hook and then the lid is closed, so as to cross the closed planar area only once. Therefore, this allows easy attachment and detachment of the strap without tying the knot which is required in the conventional way that the main part of the strap is put through the small loop.

According to the second embodiment, the place where the hook and the projection come in contact with each other with the lid closed is not located at least on the same side as the slot with respect to the base part of the hook. Therefore, the attached strap is not accidentally detached from the main body with the lid closed.

The structure of the hook described above is merely one example, and the hook may have an L-shape as in the first embodiment.

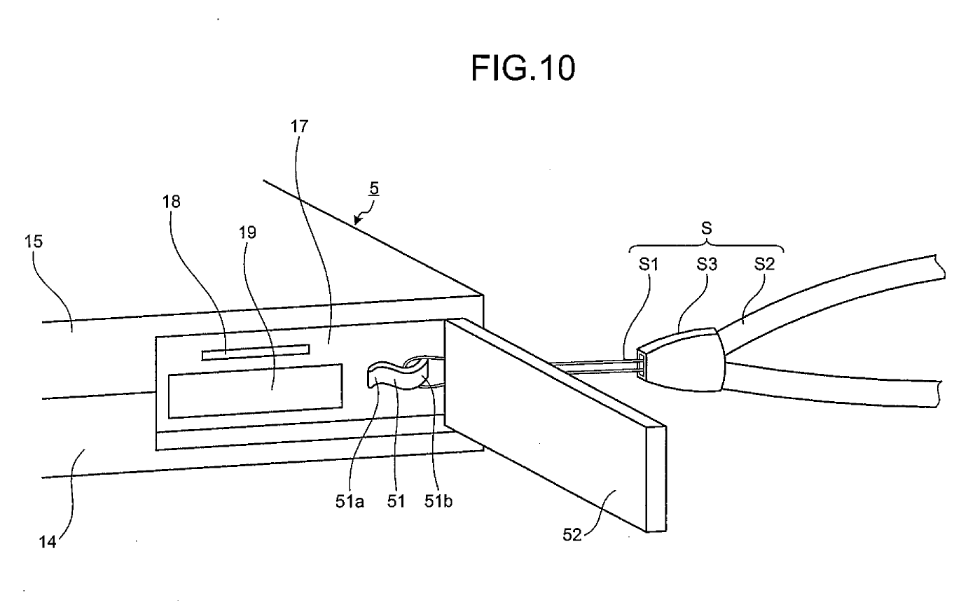

FIG. 10 shows a structure of main parts of a digital camera, which is a portable electronic apparatus according to a third embodiment of the present invention. A digital camera 5 shown in FIG. 10 is different from the digital camera 1 described in the first embodiment in the structures of the hook and the lid. The other parts and their structure are the same as those of the digital camera 1 according to the first embodiment. Accordingly, the same parts as those of the digital camera 1 are denoted by the corresponding reference numerals in FIG. 3.

A hook 51 is formed from wavy plate-like member, and specifically has a head part 51a being possible to be lifted from the bottom of the recess 17 which is the boundary surface of the covered area, and a base part 51b firmly attached to the bottom of the recess 17. The hook 51 is made of a flexible material. Accordingly, when the hook 51 is bent by a pulling force, the head part 51a is lifted; when the force is released, the head part 51a returns by its own restoring force to its original state, i.e., the state where the head part 51a comes in contact with the bottom of the recess 17.

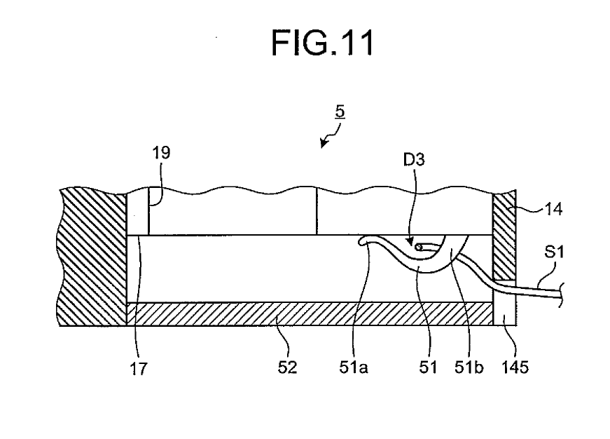

FIG. 11 shows a structure of the area covered with a flat plate lid 52, with the lid 52 closed. As shown in FIG. 11, the head part 51a of the hook 51 is warped in a direction opposite to the bottom of the recess 17 around the contact portion of the head part 51a with the bottom of the recess 17, so that the small loop S1 is easily attached and detached.

The hook 51, having the structure described above, forms a closed planar area D3 together with the bottom of the recess 17, which is a portion of the boundary surface, with the head part 51a coming in contact with the bottom of the recess 17. Accordingly, the small loop S1 hooked on to the hook 51 crosses the planar area D3 only once, thereby is prevented from being detached from the digital camera 5.

As described above, in the third embodiment, the hook 51 is provided in the covered area, of the main body, covered with the lid 52, and forms the closed planar area D3 together with the bottom of the recess 17, which is a boundary surface of the covered area.

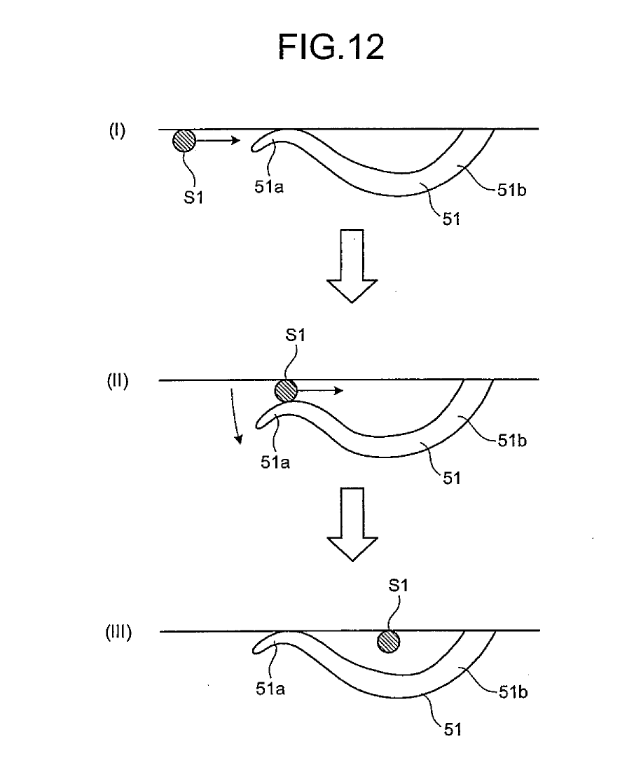

FIG. 12 schematically illustrates how the small loop S1 is hooked on to the hook 51. First, as shown in FIG. 12(I), the small loop S1, which enters the covered area through the slot 145, approaches the head part 51a of the hook 51 from a side (left side in FIG. 12) opposite to a side on which the slot 145 is provided with respect to the hook 51. Then, as the strap S is pulled toward the slot 145, i.e., substantially rightward in FIG. 12, the small loop S1 comes in contact with the head part 51a and the head part 51a is lifted from the bottom of the recess 17, as shown in FIG. 12(II). After that, as the small loop S1 is continued being pulled, the small loop S1 enters the planar area D3 and is hooked on to the hook 51, as shown in FIG. 12(III). Thus, the small loop S1 is hooked on to the hook 51 easily.

To detach the strap S from the digital camera 5, the small loop S1 may be detached easily from the hook 51, by following the steps described above in a reverse sequence.

In the third embodiment, the head part 51a of the hook 51 with the strap S attached is not located at least on the same side as that on which the slot 145 is provided, with respect to the base part 51b of the hook 51. In addition, the rotational axis of the lid 52 is located in between the hook 51 and the slot 145. Therefore, the closed lid 52 will not be opened even if the user pulls the strap in any direction. Accordingly, the strap S is not accidentally detached from the digital camera 5, and the digital camera 5 is hung with the strap S reliably.

The portable electronic apparatus according to the third embodiment of the present invention described above includes the hook which is provided in an area of the main body to be covered with the lid and on which the small loop for attachment of the strap is hooked, so that the head part of the hook can be lifted from the boundary surface of the covered area. The closed planar area is formed by the boundary surface of the covered area and the hook, at least with the lid closed. Accordingly, the strap can be attached in a manner that the small loop is hooked on to the hook so as to cross the closed planar area only once. This allows easy attachment and detachment of the strap, without tying the knot which is required in the conventional way that the main part of the strap is put through the small loop.

According to the third embodiment, the head part of the hook is not located at least on the same side as the slot with respect to the base part of the hook, and thus the strap is not accidentally detached from the main body with the lid closed.

The hook may have a shape different from the hook 51. For example, the head part of the hook may be tapered so that the small loop S1 is hooked more easily. Alternatively, the hook may be long and slender like a clip of a pen.

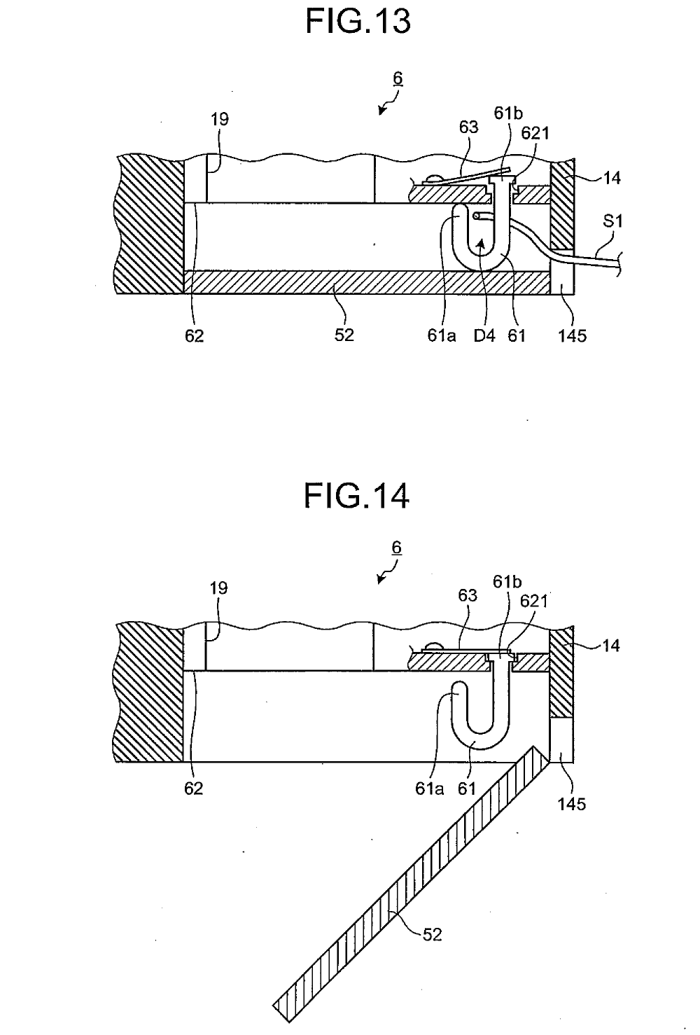

FIG. 13 shows a structure of bottom main parts of a digital camera, which is a portable electronic apparatus according to a fourth embodiment of the present invention. A digital camera 6 shown in FIG. 13 is different from the digital camera 5 according to the third embodiment in the structures of the hook and the bottom of the recess. The other parts and their structure of the digital camera 6 are the same as those of the digital camera 5. The same parts as those of the digital camera 5 in FIG. 13 are denoted by the corresponding reference numerals in FIG. 11.

A hook 61 has a head part 61a which can be lifted from the boundary surface of the covered area, and a base part 61b which has a flange. The base part 61b is anchored so that the flange is engaged with a tiered hole 621 provided on the bottom of a recess 62, and is movable in the direction perpendicular to the bottom of the recess 62. The hook 61 is a rod or a plate member which has U-shaped lateral side.

With a flat lid 52 closed, i.e., in the state shown in FIG. 13, the head part 61a comes in contact with the bottom of the recess 62, which is a part of the boundary surface of the covered area. The hook 61 forms a closed planar area D4 together with the bottom of the recess 62. The base part 61b is biased toward the lid 52 by a leaf spring 63.

FIG. 14 shows the structure of bottom main parts of the digital camera 6 with the lid 52 opened. With the lid 52 opened, the base part 61b is pressed toward the lid 52 by the elastic force of the leaf spring 63. Accordingly, the head part 61a is lifted from the bottom of the recess 62, so that a gap through which the small loop S1 passes is formed therebetween.

Starting from the state shown in FIG. 14, the small loop S1 is hooked on to the hook 61 through the gap between the head part 61a and the bottom of the recess 62. Then closing the lid 52, the head part 61a comes in contact with the bottom of the recess 62, resulting in the state as shown in FIG. 13. The small loop S1 hooked on to the hook 61 so as to cross the planar area D4 only once, is not detached from the hook 61 as far as the lid 52 is closed.

In the fourth embodiment, the head part 61a is not located at least on the same side as the slot 145 with respect to the base part 61b. In addition, the rotational axis of the lid 52 is located in between the hook 61 and the slot 145. Therefore, with the lid 52 closed, even if the user pulls the strap S in any direction, the lid 52 will not be opened. This configuration prevents the strap S from being detached from the digital camera 6, and allows the digital camera 6 to be hung with the strap S reliably.

As described above, the portable electronic apparatus according to the fourth embodiment of the present invention includes the hook which is provided in an area of the main body to be covered with the lid and on which the small loop for the attachment of the strap is hooked, so that the head part of the hook can be lifted from the boundary surface of the covered area. The closed planar area is formed by the boundary surface of the covered area and the hook, at least with the lid closed. Accordingly, the strap can be attached in a manner that the small loop is hooked on to the hook and then the lid is closed so as to cross the closed planar area only once. This allows easy attachment and detachment of the strap, without tying the knot which is required in the conventional way that the main part of the strap is put through the small loop.

According to the fourth embodiment, the head part of the hook is not located at least on the same side as the slot with respect to the base part of the hook, and thus the strap is not accidentally detached from the main body with the lid closed.

The hook may be pressed by an elastic member other than the leaf spring, such as a rubber membrane. Moreover, the configuration that biases the hook by the elastic member may be replaced with a click mechanism that lifts the head part of the hook from the bottom of the recess and causes the head part to come in contact with the bottom of the recess.

The first to the fourth embodiments are described above in detail as the best modes for carrying out the invention. However, the present invention is not limited to these four embodiments. The portable electronic apparatuses according to the present invention are not limited to digital cameras. They may be, for example, other portable cameras; portable communication terminals such as mobile phones, PESs (Personal Handyphone Systems) and PDAs (Personal Digital Assistants); portable audio devices; digital voice recorders; portable radios; remote controllers for various home electric appliances; digital video recorders; and the like.

In the case where the portable electronic apparatus according to the present invention has such a structure that a lid covers an interface for connection with the external device, including a DC input terminal and a USB (Universal Serial Bus) terminal, the strap attaching part may be provided on an area of the interface covered.

The strap attached to the portable electronic apparatus according to the present invention has only to have a small loop for attachment. For example, even an ornamental strap with an ornamental member connected to the connecting part may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic apparatus comprising:
an exterior member which houses a main body of the apparatus and has an opening, a part of the main body being exposed through the opening;
a lid which is attached to the exterior member so as to cover or uncover the opening;
a hook which is provided in an area of the main body to be covered with the lid and on which a small loop for attachment of a strap is hooked; and
a projection which projects from the lid and which comes in contact with a head part of the hook with the lid closed, wherein
a boundary surface of the covered area, the hook, and the projection forms a closed planar area with the lid closed.

2. The portable electronic apparatus according to claim 1, further comprising a slot through which the small loop is led out, wherein the head part of the hook is not located at least on a same side as the slot, with respect to a base part of the hook.

3. The portable electronic apparatus according to claim 2, wherein the lid rotates around a rotational axis to cover or uncover the opening, the rotational axis being located in between the hook and the slot.

4. A portable electronic apparatus comprising:
an exterior member which houses a main body of the apparatus and has an opening, a part of the main body being exposed through the opening;
a lid which is attached to the exterior member so as to cover or uncover the opening; and
a hook which is provided in an area of the main body to be covered with the lid and on which a small loop for attachment of a strap is hooked, a head part of the hook being possible to be lifted from a boundary surface of the covered area, wherein
the boundary surface of the covered area and the hook forms a closed planar area at least with the lid closed.

5. The portable electronic apparatus according to claim 4, further comprising a slot through which the small loop is led out, wherein the head part of the hook is not located at least on a same side as the slot, with respect to a base part of the hook.

6. The portable electronic apparatus according to claim 5, wherein the lid rotates around a rotational axis to cover or uncover the opening, the rotational axis being located in between the hook and the slot.
